(19) United States
(12) Patent Application Publication
(10) Pub. No.: US 2026/0262114 A1
(43) Pub. Date: Sep. 3, 2026

(54) PHYSICAL CHANNEL BASED COORDINATION OF TAG PROCESSING

(71) Applicant: QUALCOMM Incorporated, San Diego, CA (US)

(72) Inventors: Ahmed ELSHAFIE, San Diego, CA (US); Huilin XU, Beijing (CN); Zhikun WU, Beijing (CN); Wei YANG, San Diego, CA (US)

(21) Appl. No.: 19/159,966

(22) PCT Filed: Apr. 11, 2023
(86) PCT No.: PCT/CN2023/087541

§ 371 Date: Aug. 26, 2025

(51) Int. Cl. H04W 76/14; H04L 27/26

(52) U.S. Cl. CPC H04W 76/14; H04L 27/2601

(57) ABSTRACT

Various aspects of the present disclosure generally relate to wireless communication. In some aspects, a first user equipment (UE) may transmit, using a first physical channel message and to a second UE, a coordination message for ambient device processing associated with an ambient device. The UE may transmit, based at least in part on transmitting the coordination message and to an ambient device, a tag message associated with the ambient device processing. The UE may receive, using a second physical channel message and from the second UE, an ambient device processing feedback message associated with the ambient device processing, based at least in part on transmitting the coordination message and the tag message. Numerous other aspects are described.

### FIELD OF THE DISCLOSURE

Aspects of the present disclosure generally relate to wireless communication and to techniques and apparatuses for physical channel based coordination of tag processing.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a first user equipment (UE). The method may include transmitting, using a first physical channel message and to a second UE, a coordination message for ambient device processing associated with an ambient device. The method may include transmitting, based at least in part on transmitting the coordination message and to an ambient device, a tag message associated with the ambient device processing. The method may include receiving, using a second physical channel message and from the second UE, an ambient device processing feedback message associated with the ambient device processing, based at least in part on transmitting the coordination message and the tag message.

Some aspects described herein relate to a method of wireless communication performed by a second UE. The method may include receiving, using a first physical channel message and from a first UE, a coordination message for ambient device processing associated with an ambient device. The method may include performing an ambient device processing operation based at least in part on receiving the coordination message. The method may include transmitting, using a second physical channel message and to the first UE, an ambient device processing feedback message associated with the ambient device processing operation.

Some aspects described herein relate to a first UE for wireless communication. The first user equipment may include a memory and one or more processors coupled to the memory. The one or more processors may be configured to transmit, using a first physical channel message and to a second UE, a coordination message for ambient device processing associated with an ambient device. The one or more processors may be configured to transmit, based at least in part on transmitting the coordination message and to an ambient device, a tag message associated with the ambient device processing. The one or more processors may be configured to receive, using a second physical channel message and from the second UE, an ambient device processing feedback message associated with the ambient device processing, based at least in part on transmitting the coordination message and the tag message.

Some aspects described herein relate to a second UE for wireless communication. The second user equipment may include a memory and one or more processors coupled to the memory. The one or more processors may be configured to receive, using a first physical channel message and from a first UE, a coordination message for ambient device processing associated with an ambient device. The one or more processors may be configured to perform an ambient device processing operation based at least in part on receiving the coordination message. The one or more processors may be configured to transmit, using a second physical channel message and to the first UE, an ambient device processing feedback message associated with the ambient device processing operation.

Some aspects described herein relate to a non-transitory computer-readable medium that stores a set of instructions for wireless communication by a first UE. The set of instructions, when executed by one or more processors of the UE, may cause the UE to transmit, using a first physical channel message and to a second UE, a coordination message for ambient device processing associated with an ambient device. The set of instructions, when executed by one or more processors of the UE, may cause the UE to transmit, based at least in part on transmitting the coordination message and to an ambient device, a tag message associated with the ambient device processing. The set of instructions, when executed by one or more processors of the UE, may cause the UE to receive, using a second physical channel message and from the second UE, an ambient device processing feedback message associated with the ambient device processing, based at least in part on transmitting the coordination message and the tag message.

Some aspects described herein relate to a non-transitory computer-readable medium that stores a set of instructions for wireless communication by a second UE. The set of instructions, when executed by one or more processors of the UE, may cause the UE to receive, using a first physical channel message and from a first UE, a coordination message for ambient device processing associated with an ambient device. The set of instructions, when executed by one or more processors of the UE, may cause the UE to perform an ambient device processing operation based at least in part on receiving the coordination message. The set of instructions, when executed by one or more processors of the UE, may cause the UE to transmit, using a second physical channel message and to the first UE, an ambient device processing feedback message associated with the ambient device processing operation.

Some aspects described herein relate to an apparatus for wireless communication. The apparatus may include means for transmitting, using a first physical channel message and to a second UE, a coordination message for ambient device processing associated with an ambient device. The apparatus may include means for transmitting, based at least in part on transmitting the coordination message and to an ambient device, a tag message associated with the ambient device processing. The apparatus may include means for receiving, using a second physical channel message and from the second UE, an ambient device processing feedback message associated with the ambient device processing, based at least in part on transmitting the coordination message and the tag message.

Some aspects described herein relate to an apparatus for wireless communication. The apparatus may include means for receiving, using a first physical channel message and from a first UE, a coordination message for ambient device processing associated with an ambient device. The apparatus may include means for performing an ambient device processing operation based at least in part on receiving the coordination message. The apparatus may include means for transmitting, using a second physical channel message and to the first UE, an ambient device processing feedback message associated with the ambient device processing operation.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of backscatter communication in an interrogator-talks-first (ITF) tag processing procedure, in accordance with the present disclosure.

FIGS. 5A and 5B are diagrams illustrating examples of backscatter communication, in accordance with the present disclosure.

FIG. 6 is a diagram illustrating an example associated with physical channel based coordination of tag processing, in accordance with the present disclosure.

FIG. 7 is a diagram illustrating an example process performed, for example, by a first UE, in accordance with the present disclosure.

FIG. 8 is a diagram illustrating an example process performed, for example, by a second UE, in accordance with the present disclosure.

FIG. 9 is a diagram of an example apparatus for wireless communication, in accordance with the present disclosure.

### DETAILED DESCRIPTION

Ambient devices, such as radio frequency identification (RFID) devices, use electromagnetic fields to wirelessly transfer data between a reader, such as a user equipment (UE) and an ambient device. A tag (e.g., an RFID tag) includes an element of a microchip that stores data and includes or is associated with an antenna that communicates with the reader. When the reader emits a radio signal, the antenna of the tag receives the signal and uses energy of the radio signal to power the microchip. The microchip modulates the signal and sends a response, which may include data being stored by a memory of the tag. The reader identifies the response and interprets the response to, for example, read the data.

The range at which an RFID tag can be read may be based at least in part on various factors, such as a frequency used, a size and type of an antenna, and an environment (e.g., a presence of interference). In a first configuration, which may be referred to as a “monostatic configuration,” a UE can transmit a signal to an ambient device via a forward link (FL) and receive a response from the ambient device via a backscatter link (BL). In a second configuration, which may be referred to as a “bistatic configuration”, a first UE can transmit the signal to an ambient device via the forward link, and a second UE may receive the response from the ambient device via the backscatter link.

An antenna sensitivity, for reception, of a single monostatic antenna may be, in some examples, less than the antenna sensitivity, for reception, of multiple antennas (e.g., such as in the bistatic configuration). Accordingly, the bistatic configuration may be used when a power of a response from an ambient device, which may be referred to as a “backscatter reception power” is less than a threshold amount. In other words, when the backscatter reception power is less than an amount detectable by a single transmit/receive antenna in a monostatic configuration, the backscatter reception power may still be detectable by receive antenna (separate from a transmit antenna) in a bistatic configuration. Moreover, bistatic configuration tag processing may be simpler to implement as each UE, in the bistatic configuration, can be half-duplex rather than requiring, as in the monostatic configuration, a single full-duplex UE. However, a reception UE, in the bistatic configuration, may lack information indicating a resource on which the reception UE is to perform a tag processing operation, such as tag reading (e.g., detecting a backscatter response message from an ambient device). Similarly, in other modes of tag processing (e.g., transmitting information to the ambient device to, for example, update a memory of the ambient device) a second UE may lack information indicating on which resources the ambient device can receive a transmission.

Some aspects described herein enable physical channel based coordination of tag processing. For example, a first UE may transmit, via a physical channel (e.g., a sidelink (SL), a Uu link, or a dedicated link), a coordination message to a second UE to coordinate ambient device processing, and the first UE may receive a response message confirming receipt of the coordination message. Based at least in part on receiving the response message, the first UE transmits a tag message to an ambient device to trigger, for example, backscatter transmission by the ambient device and to the second UE, which receives the backscatter transmission. The second UE may transmit a feedback message, via a physical channel, based at least in part on receiving the backscatter transmission and the first UE may transmit a response to the feedback message to complete an ambient device processing procedure. In this way, by using a physical channel for coordination, the first UE and the second UE enable bistatic configuration tag processing, thereby enabling reception of a backscatter transmission with a reduced backscatter reception power than is achievable using monostatic configuration tag processing.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

Particular aspects of the subject matter described in this disclosure can be implemented to realize one or more of the following potential advantages. In some examples, by using a physical channel for coordination and enabling bistatic configuration tag processing, the described techniques can be used to enable reception of a backscatter transmission with a reduced backscatter reception power than is achievable using monostatic configuration tag processing.

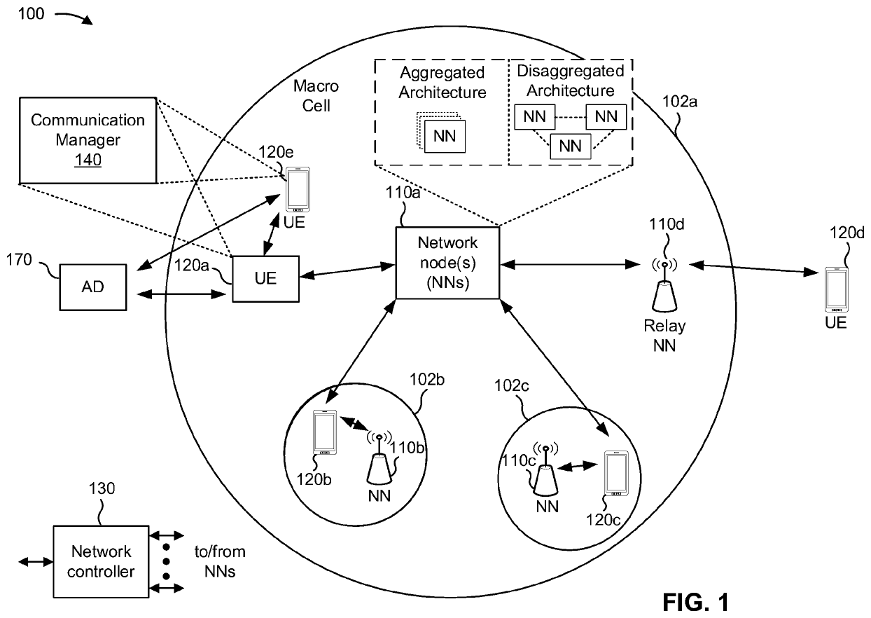

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In some examples, the wireless network 100 may include an ambient device 170. For example, an ambient device 170 may communicate with a network node 110 (e.g., via an access link) and/or one or more UEs 120 (e.g., via a sidelink). In some examples, an ambient device 170 may include or be included in a tag device or an RFID device. For example, the ambient device 170 may transmit or receive information associated with RFID reading, tag reading, or another type of tag processing procedure.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit, using a first physical channel message and to a another UE, a coordination message for ambient device processing associated with an ambient device; transmit, based at least in part on transmitting the coordination message and to an ambient device, a tag message associated with the ambient device processing; and receive, using a second physical channel message and from another UE, an ambient device processing feedback message associated with the ambient device processing, based at least in part on transmitting the coordination message and the tag message. Additionally, or alternatively, the communication manager 140 may receive, using a first physical channel message and from another UE, a coordination message for ambient device processing associated with an ambient device; perform an ambient device processing operation based at least in part on receiving the coordination message; and transmit, using a second physical channel message and to another UE, an ambient device processing feedback message associated with the ambient device processing operation. Additionally, or alternatively, the communication manager 140 may perform one or more other operations described herein.

As indicated above, FIG. 1 is provided as an example. Other examples may differ from what is described with regard to FIG. 1.

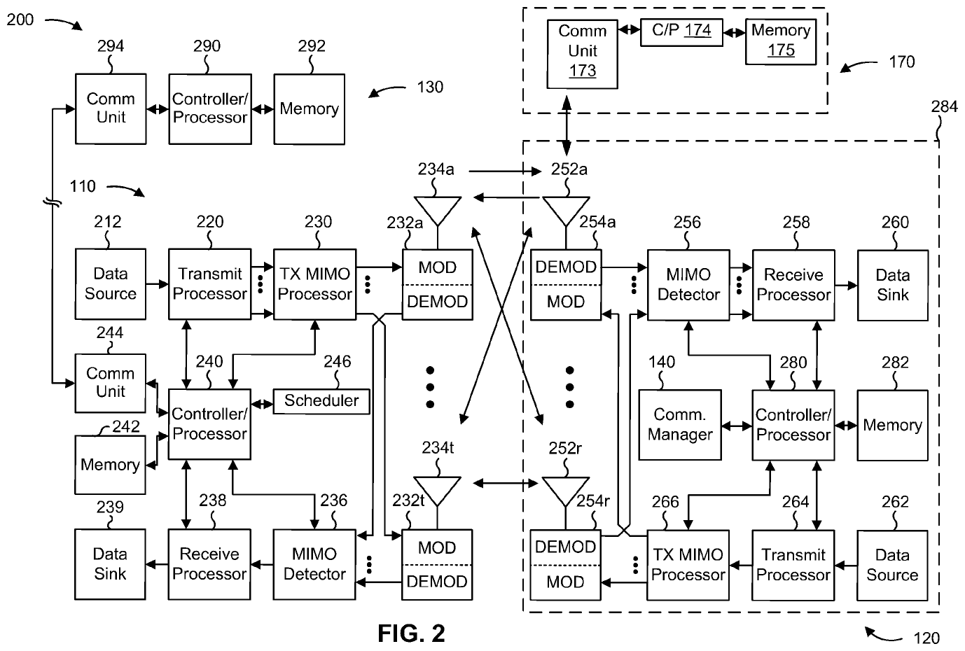

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

The ambient device 170 may include a communication unit 173, a controller/processor 174, and a memory 175. Additionally, or alternatively, the ambient device 170 may include one or more components described with regard to the network node 110 or the UE 120, such as one or more antennas, modulators, or demodulators, among other examples.

The ambient device 170 may communicate with the UE 120 or, in some examples, the network node 110 via the communication unit 173.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

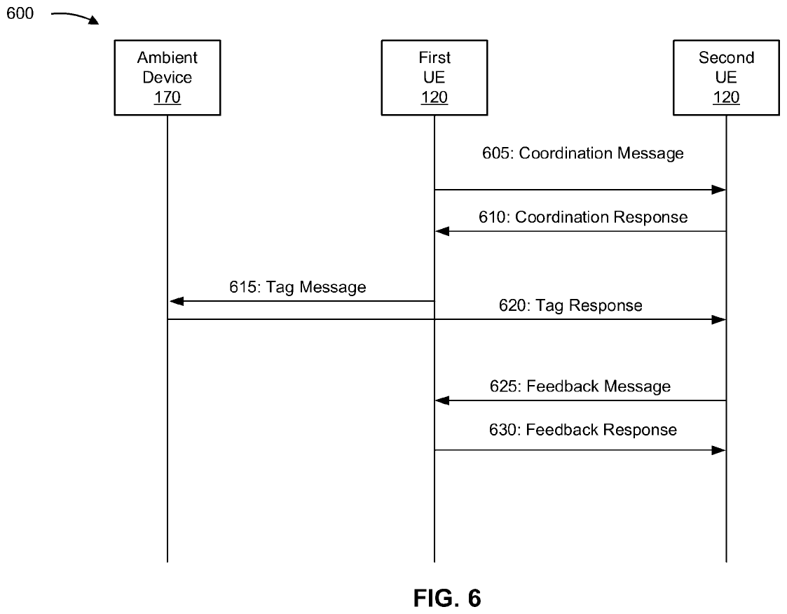

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-9).

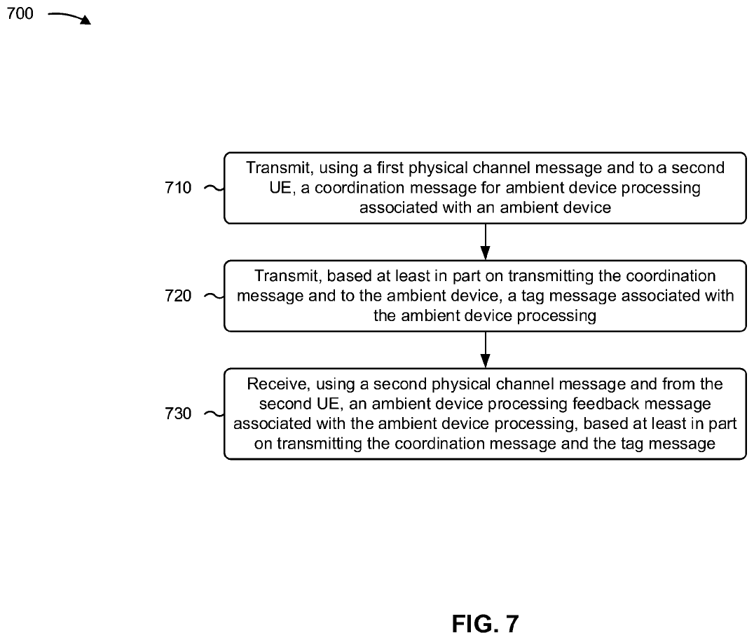

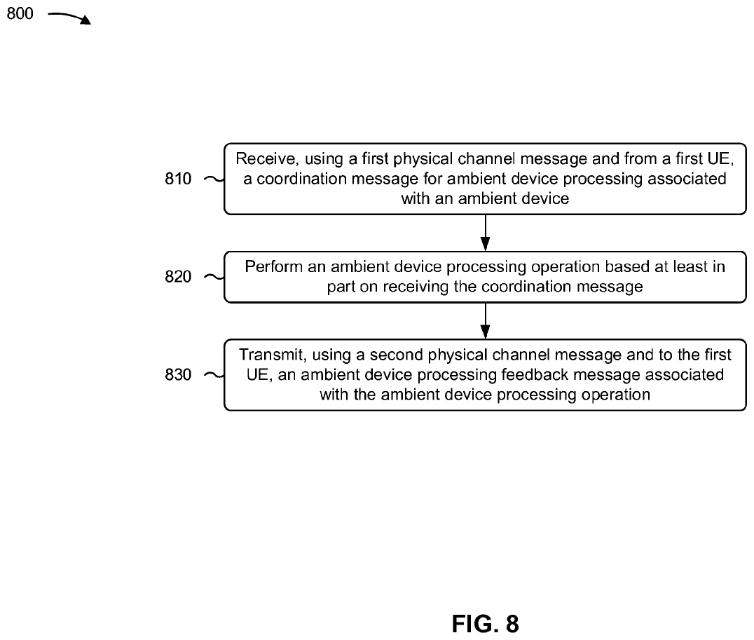

The controller/processor 240 of the network node 110, the controller/processor 280 of the UE 120, and/or any other component(s) of FIG. 2 may perform one or more techniques associated with physical channel based coordination of tag processing, as described in more detail elsewhere herein. For example, the controller/processor 240 of the network node 110, the controller/processor 280 of the UE 120, controller/processor 174 of the ambient device 170, and/or any other component(s) of FIG. 2 may perform or direct operations of, for example, process 700 of FIG. 7, process 800 of FIG. 8, and/or other processes as described herein. The memory 242, the memory 282, and the memory 175 may store data and program codes for the network node 110, the UE 120, and the ambient device 170, respectively. In some examples, the memory 242, the memory 282, and/or the memory 175 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110, the UE 120, and/or the ambient device 170 may cause the one or more processors, the UE 120, the network node 110, and/or the ambient device 170 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, a first UE 120 includes means for transmitting, using a first physical channel message and to a second UE 120, a coordination message for ambient device processing associated with an ambient device 170; means for transmitting, based at least in part on transmitting the coordination message and to an ambient device 170, a tag message associated with the ambient device processing; and/or means for receiving, using a second physical channel message and from the second UE 120, an ambient device processing feedback message associated with the ambient device processing, based at least in part on transmitting the coordination message and the tag message. In some aspects, a second UE 120 includes means for receiving, using a first physical channel message and from a first UE 120, a coordination message for ambient device processing associated with an ambient device 170; means for performing an ambient device processing operation based at least in part on receiving the coordination message; and/or means for transmitting, using a second physical channel message and to the first UE 120, an ambient device processing feedback message associated with the ambient device processing operation. The means for the first UE 120 or the second UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

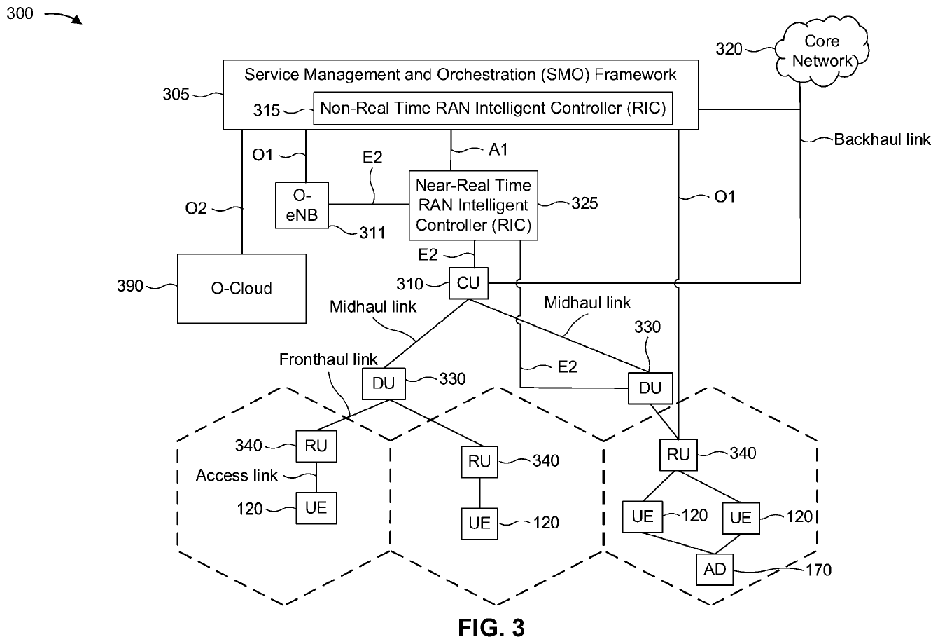

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit—User Plane (CU-UP) functionality), control plane functionality (for example, Central Unit—Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as Al interface policies).

As indicated above, FIG. 3 is provided as an example. Other examples may differ from what is described with regard to FIG. 3.

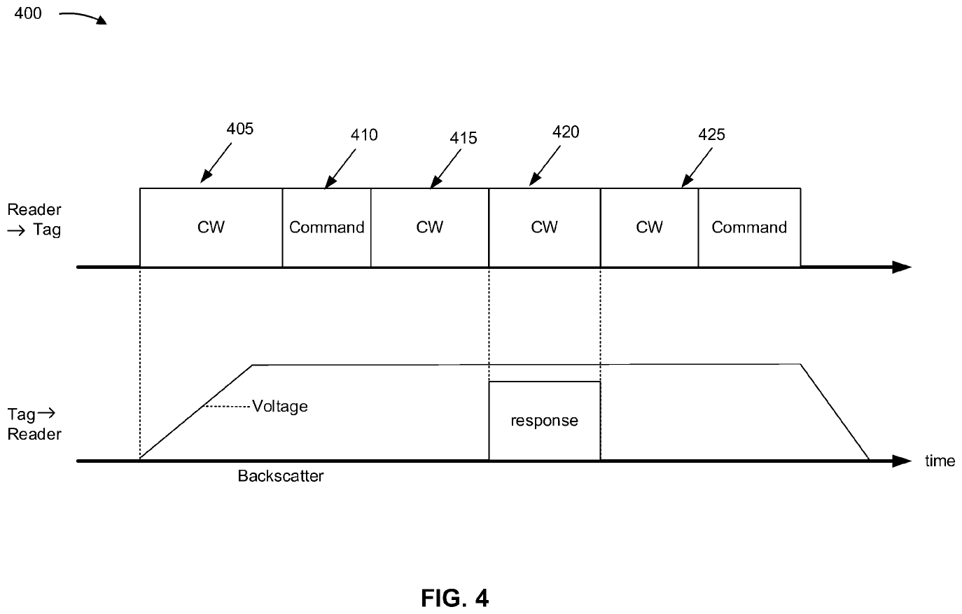

FIG. 4 is a diagram illustrating an example 400 of backscatter communication in an interrogator-talks-first (ITF) tag processing procedure, in accordance with the present disclosure.

As shown in FIG. 4, in backscatter communication, a reader (e.g., a UE) may communicate with a tag of an ambient device. The reader may transmit a radio signal to the tag, and the tag may receive the signal using an antenna. The antenna may use energy of the radio signal to power a microchip of the ambient device. For example, in a first time period 405, the reader device transmits a continuous wave (CW) unmodulated signal to the ambient device, which results in a voltage increase at the ambient device (e.g., powering the ambient device). At a second time period 410, after the ambient device is powered on by the unmodulated signal, the reader device transmits information to the ambient device. For example, the reader device may transmit a command with a radio signal power at a threshold level (e.g., ≥20 decibel milliwatts (dBm)) to maintain the ambient device in an on state.

At time periods 415 and 420, the reader device transmits the continuous wave unmodulated signal after transmitting the command to maintain the ambient device in an on state to allow the ambient device to transmit a response message, as shown. The reader may receive the response message, which may be a backscatter reception, and, at time period 425, the reader device transmits another command to the ambient device (e.g., an acknowledgment of the backscatter reception or a command indicating that the ITF tag processing procedure is complete). After transmitting the command, the reader may stop transmitting a continuous wave unmodulated signal, which may result in the voltage of the ambient device reducing to an off state of the ambient device.

As indicated above, FIG. 4 is provided as an example. Other examples may differ from what is described with respect to FIG. 4.

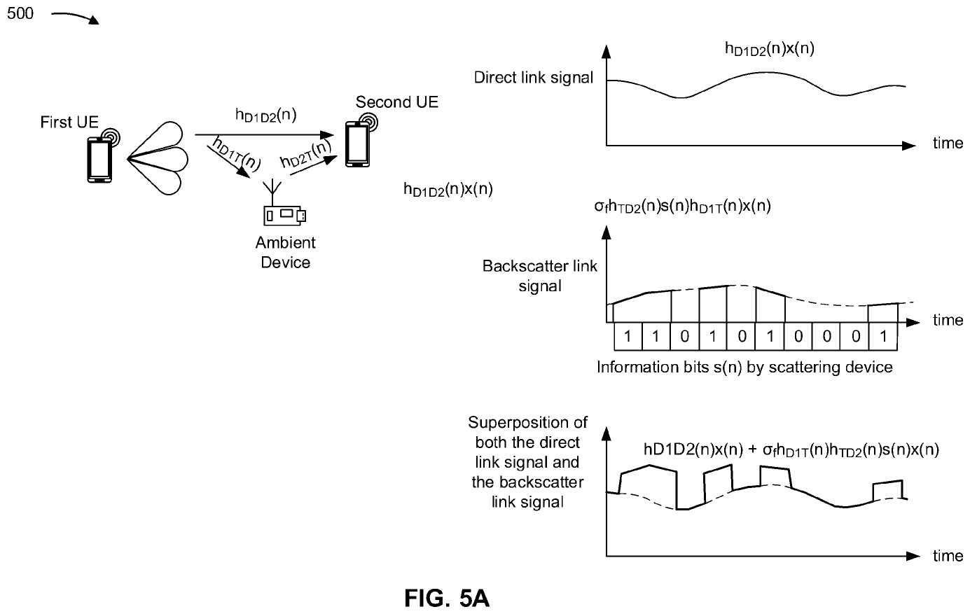

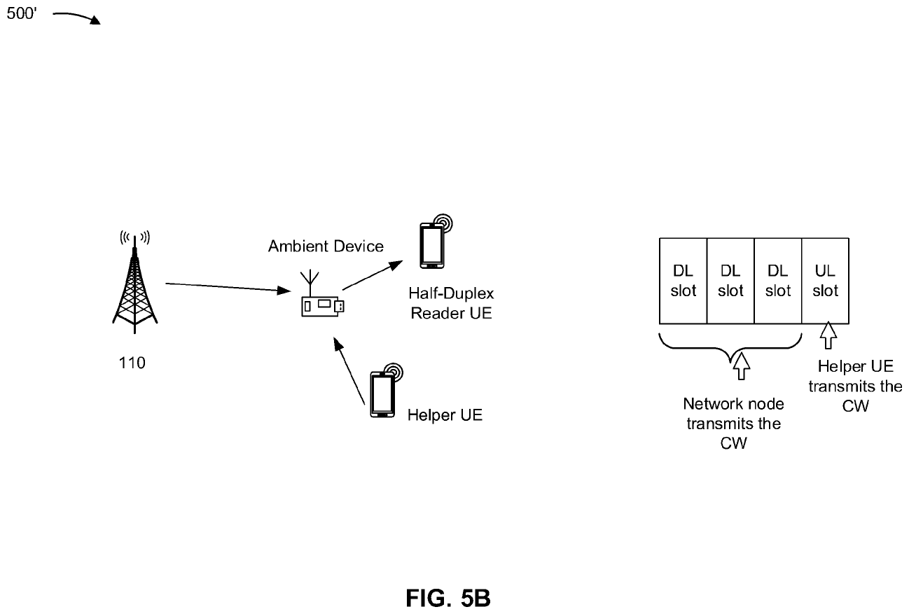

FIGS. 5A and 5B are diagrams illustrating examples 500/500′ of backscatter communication, in accordance with the present disclosure.

In one example, communication with the ambient device may be performed using amplitude shift keying (ASK), in which the ambient device switches on reflection (backscatter) to transmit an information bit “1” and switches off reflection to transmit an information bit “0”. In this example, the first UE can transmit a radio wave x(n), and the ambient device may have information bits s(n). In this case, a received signal at the second UE is y(n)=(h_{D1D2}(n)+σ_{f}h_{D1T}(n)h_{TD2}(n)s(n))x(n)+q, where q represents noise associated with channel conditions of links between the first UE, the second UE, and the ambient device, and where h represents a link signal function. Accordingly, when s(n)=0 (e.g., an information bit “0” associated with backscatter being switched off at the ambient device), the second UE receives a direct link signal y(n)=h_{D1D2}(n)x(n)+q. Similarly, when s(n)=1 (e.g., an information bit “1” associated with backscatter being switched on at the ambient device), the second UE receives, y(n)=(h_{D1D2}(n)+σ_{f}h_{D1T}(n)h_{TD2}(n)s(n))x(n)+q, where of is a reflection coefficient and y(n) is a superposition of both a direct link signal (e.g., between the first UE and the second UE) and a backscatter link signal from the ambient device.

As shown in FIG. 5B and example 500′, a network node 110 can configure UEs and allocate resources for ambient device tag processing. For example, the network node 110 may transmit a continuous wave unmodulated signal in a set of downlink slots to power on the ambient device, and a helper UE may transmit a continuous wave unmodulated signal or a command in an uplink slot. In this case, a half-duplex reader UE may be configured to receive a backscatter reflected signal from the helper UE in the uplink slot based at least in part on the ambient device backscattering the continuous wave unmodulated signal or the command in the uplink slot.

As indicated above, FIGS. 5A and 5B are provided as an example. Other examples may differ from what is described with respect to FIGS. 5A and 5B.

As described above, ambient devices, such as RFID devices, use electromagnetic fields to wirelessly transfer data between a reader, such as a UE, and an ambient device. The range at which an RFID tag can be read may be based at least in part on various factors, such as a frequency used, a size and type of an antenna, and an environment (e.g., a presence of interference). In a monostatic configuration, a single UE can transmit a signal to an ambient device via an forward link and receive a response from the ambient device via a backscatter link. In a bistatic configuration, a first UE can transmit the signal to an ambient device via the forward link, and a second UE may receive the response from the ambient device via the backscatter link.

An antenna sensitivity, for reception, of a single monostatic antenna (e.g., an antenna that transmits and receives) may be, in some examples, less than the antenna sensitivity, for reception, of a set of multiple antennas (e.g., a first antenna that transmits and a second antenna that receives) in a bistatic configuration. Accordingly, the bistatic configuration may be used when a backscatter reception power from an ambient device is less than a threshold amount. In other words, when the backscatter reception power is less than an amount detectable by a single transmit/receive antenna in a monostatic configuration, the backscatter reception power may still be detectable by a receive antenna (separate from a transmit antenna) in a bistatic configuration. Moreover, bistatic configuration tag processing may be simpler to implement as each UE, in the bistatic configuration, can be half-duplex rather than requiring, as in the monostatic configuration, a single full-duplex UE. However, a reception UE, in the bistatic configuration, may lack information indicating a resource on which the reception UE is to perform a tag processing operation, such as tag reading (e.g., detecting a backscatter response message from an ambient device). Similarly, in other modes of tag processing (e.g., transmitting information to the ambient device to, for example, update a memory of the ambient device), a second UE may lack information indicating on which resources the ambient device can receive a transmission.

Some aspects described herein enable physical channel based coordination of tag processing. For example, a first UE may transmit, via a physical channel (e.g., an SL, a Uu link, or a dedicated link), a coordination message to a second UE to coordinate ambient device processing, and the first UE may receive a response message confirming receipt of the coordination message. Based at least in part on receiving the response message the first UE transmits a tag message to an ambient device to trigger, for example, backscatter transmission by the ambient device and to the second UE, which receives the backscatter transmission. The second UE may transmit a feedback message, via a physical channel, based at least in part on receiving the backscatter transmission, and the first UE may transmit a response to the feedback message to complete an ambient device processing procedure. In this way, by using a physical channel for coordination, the first UE and the second UE enable bistatic configuration tag processing, thereby enabling reception of a backscatter transmission with a reduced backscatter reception power than is achievable using monostatic configuration tag processing.

FIG. 6 is a diagram illustrating an example 600 associated with physical channel based coordination of tag processing, in accordance with the present disclosure. As shown in FIG. 6, example 600 includes communication between a first UE 120, a second UE 120, and an ambient device 170.

As further shown in FIG. 6, and by reference numbers 605 and 610, the first UE 120 and the second UE 120 may exchange coordination messages. For example, the first UE 120 may transmit a coordination message to the second UE 120, and the second UE 120 may transmit a coordination response to the first UE 120. In some aspects, the first UE 120 and the second UE 120 may communicate one or more coordination messages (and/or one or more feedback messages as described below) via one or more links. For example, the first UE 120 and the second UE 120 may communicate via a sidelink (e.g., a PC5 interface), a Uu link (e.g., an evolved UMTS terrestrial radio access (E-UTRA) interface), or a dedicated interface (e.g., an interface specified for use in tag processing coordination). The first UE 120 may transmit a coordination message to start a tag processing procedure and/or configure the tag processing procedure, and the second UE 120 may transmit a coordination response to acknowledge the coordination message.

In some aspects, the first UE 120 and the second UE 120 may communicate via one or more PHY channels. For example, the UEs 120 may communicate via a physical downlink control channel (PDCCH), a physical uplink control channel (PUCCH), a physical downlink shared channel (PDSCH), or a physical uplink shared channel (PUSCH). In this case, a UE 120 may transmit information in the format of uplink control information (UCI) or downlink control information (DCI) to convey information associated with a tag processing operation.

In some aspects, the first UE 120 may transmit the coordination message via DCI or UCI. For example, the first UE 120 may use PDCCH or PUCCH to transmit DCI or UCI with a particular type of DCI or UCI format. In this case, the particular type of DCI or UCI format may include one or more fields for conveying information associated with coordinating tag processing operations (e.g., one or more dedicated fields or one or more fields repurposed from use for another type of parameter indication). For example, the first UE 120 may use an MCS field, a time domain resource allocation (TDRA) field, a frequency domain resource allocation (FDRA) field, or a rank indicator (RI) field (e.g., which may not be used as the DCI or UCI is not scheduling a PUSCH or a PDSCH) to convey tag processing information, such as a start or end of a tag reading process for one or more tags, a tag class, a channel state information (CSI) indicator for a link between the UEs 120, a beam management indicator for a link between the UEs 120, or a quantity of repetitions of the DCI or UCI.

In some aspects, the first UE 120 may transmit using a dedicated DCI or UCI format, such as a DCI format that is configured to enable UEs to control contents of the DCI using signaling or on a per-application basis. For example, the UEs 120 may use DCI format 2_6, which has a variable size and can be configured by a network node 110. Additionally, or alternatively, the UEs 120 may receive RRC or MAC control element (CE) (MAC-CE) signaling from a network node 110 configuring a DCI or UCI format size or set of fields. Similarly, for another DCI or UCI format, the first UE 120 may configure contents for the second UE 120 (e.g., the first UE 120 may indicate one or more parameters regarding how the second UE 120 is to interpret the DCI or UCI). In some aspects, a size of DCI may be aligned with a size of the fallback DCI (e.g., DCI format 0_0 or 1_0), and a radio network temporary identifier (RNTI) may be used to differentiate the DCI (e.g., for inter-UE coordination messages) from other DCI.

In some aspects, the first UE 120 may transmit the coordination message via DCI or UCI based at least in part on a capability. For example, the first UE 120 may have a capability of transmitting PDCCH or PUCCH. In some aspects, the first UE 120 may transmit or receive a capability indicator associated with indicating support for using DCI or UCI to convey the coordination message. For example, the first UE 120 may convey a capability indicator of support for using the DCI or UCI via a capability information message (e.g., as a response to a capability enquiry from a network node 110), an initial access message (e.g., a random access channel (RACH) message type 1 (msg1) or message type 3 (msg3)), a UE class message (e.g., a message identifying a class of the UE, from which the capability of the UE can be derived), or a message transmitted in a communication layer (e.g., a layer 1 (L1), layer 2 (L2), or layer 3 (L3) indication of a capability associated with whether one or more hardware, software, or firmware components are turned on or off to support the capability).

In some aspects, the first UE 120 may transmit the coordination message via a set of repetitions. For example, when transmitting a coordination message using DCI or UCI in a PDCCH or PUCCH, the first UE 120 may transmit a repetition of a plurality of symbols of the PDCCH or PUCCH at a beginning of the DCI or UCI to enable the second UE 120 to perform AGC in connection with receiving the DCI or UCI. In the particular case of PUCCH, the first UE 120 may, when transmitting using PUCCH formats 0, 1, 2, 3, or 4, the first UE 120 may add a repetition of symbols for the second UE 120 to use for AGC. In some aspects, the first UE 120 may use UCI based at least in part on the first UE 120 and/or the second UE 120 supporting cross-link interference (CLI) measurement using a CLI sounding reference signal (SRS) to determine an RSRP. In this case, the first UE 120 may piggyback the coordination message onto a UCI SRS.

In some aspects, a network node 110 (not shown) may configure resources, such as PDCCH or PUCCH, for the UEs 120. For example, the UEs 120 may receive information (e.g., an interUECoordinationDCIUseCase message) identifying monitoring occasions for the first UE 120 to transmit PDCCH or PUCCH-based messages and the second UE 120 to monitor for PDCCH or PUCCH-based messages. In this case, the second UE 120 may monitor a search space for a PDCCH or PUCCH-based message in accordance with a received configuration of the search space, a control resource set (CORESET), an aggregation level, or an RNTI, among other examples.

In some aspects, the first UE 120 and/or the second UE 120 may be configured (e.g., based at least in part on receiving information from the network node 110) with RNTIs for use in inter-UE messages to enable sharing of PDCCH. For example, the network node 110 may configure the same PDCCH for network node to UE communications (e.g., for wake up signal (WUS) DCI or another control message) using a first RNTI and for UE to UE communications (e.g., tag processing coordination) using a second RNTI (e.g., which may be signaled to a pair of UEs 120 or to a larger group of UEs 120). In this case, DCI or UCI configuration information may include a flag indicating whether the DCI or UCI configuration information is for network node to UE, UE to UE, or UE to UE group, among other examples of communications via PDCCH or PUCCH. Additionally, or alternatively, the DCI or UCI configuration information may include a flag indicating a type of content, such as a first DCI or UCI flag for a first type of content for UE to UE PDCCH or PUCCH communications and a second DCI or UCI flag for a second type of content for UE to UE PDCCH or PUCCH communications.

Additionally, or alternatively, for PUCCH, the first UE 120 and/or the second UE 120 may share the PUCCH using different cyclic shifts (CS) (e.g., 2-bit CSs with 1 bit for a network node and 1 bit for a UE 120). Additionally, or alternatively, the UEs 120 may receive information indicating an orthogonal cover code (OCC) for the UEs 120 to use when transmitting UCI to a network node or to each other on a shared PUCCH resource. In this case, the second UE 120 may receive information identifying an OCC from a network node 110 or from the first UE 120 (e.g., via a dedicated, groupcast, or group-common transmission). In this case, a single PUCCH can be used for groupcast for a plurality of second UEs 120 using the same OCC or a configured group-common OCC or can be unicast with different PUCCH configurations and/or RNTI sequences. In some aspects, the UEs 120 may be configured with an RNTI or search space associated with resources for, for example, groupcast or group-common communications.

In some aspects, the second UE 120 may decode a PDCCH or PUCCH to receive DCI or UCI conveying a coordination message. For example, the second UE 120 may decode a set of control channel elements (CCEs) associated with PDCCH or PUCCH to receive the DCI or UCI. In some aspects, the PDCCH or PUCCH may have one or more limitations, such as a blind decoding (BD) limitation or a CCE limitation.

In some aspects, when the second UE 120 receives DCI or UCI from the first UE 120, the second UE 120 may not expect to receive signaling from the network node 110 in a same resource (e.g., the second UE 120 may treat such scheduling as an error case and may drop one or more signals). Additionally, or alternatively, the second UE 120 may determine whether to receive the DCI or UCI based at least in part on a DCI or UCI priority. For example, DCI from a network node 110 may have a higher priority than DCI from a first UE 120, which may result in the second UE 120 skipping DCI from the first UE 120 to enable reception of DCI from a network node 110. In some aspects, a DCI priority for DCI from, for example, the first UE 120 may be configured on a per PDCCH or PUCCH monitoring occasion basis.

In some aspects, the UEs 120 may determine a transmission configuration indicator (TCI) state or other beam parameter for the coordination messages. For example, for a CORESET of an inter-UE PDCCH or PUCCH, the UEs 120 may use a TCI state of a PDSCH (e.g., for network node to UE communication). Additionally, or alternatively, the UEs 120 may receive configuration information identifying a TCI state or quasi-co-location (QCL) parameter for one or more inter-UE DCI or UCI messages.

In some aspects, the UEs 120 (e.g., the first UE 120 and/or the second UE 120) may communicate using RRC signaling. For example, the second UE 120 may receive PDCCH or PUCCH RRC configuration signaling with a flag indicating that the PDCCH or PUCCH RRC configuration signaling is being used for inter-UE PDCCH or PUCCH. Additionally, or alternatively, the flag may indicate that the RRC configuration signaling is for network node to UE signaling or for both inter-UE and network node to UE signaling (e.g., with different contents in the RRC configuration signaling). In some aspects, the flag may be included in PDCCH or PUCCH configuration information, a CORESET, or a search space set group (e.g., for monitoring PDCCH or PUCCH from a network node to a UE 120, which may be the same search space set group for network node to UE and inter-UE communication and may be based at least in part on which pair of UEs 120 receive the configuration information). In other words, when the flag is in a PDCCH or PUCCH configuration, there may be two PDCCH or PUCCH configurations with one for inter-UE PDCCH or PUCCH and one for network node to UE PDCCH or PUCCH. In contrast, when the flag is in a CORESET or search space (SS) set, one or more parameters may be shared between inter-UE PDCCH or PUCCH and network node to UE PDCCH or PUCCH.

As further shown in FIG. 6, and by reference numbers 615 and 620, the first UE 120, the second UE 120, and the ambient device 170 may perform tag processing operations associated with a tag processing procedure. For example, the first UE 120 may transmit a tag message to the ambient device 170, and the ambient device 170 may backscatter a tag response to the second UE 120.

In some implementations, to perform tag processing operations, the first UE 120 may transmit a signal, and the second UE 120 may receive a backscatter of the signal. For example, the first UE 120 may transmit a signal to the ambient device 170, and the ambient device 170 may backscatter the signal to the second UE 120. In this case, the signal may be transmitted and/or backscattered using a particular physical channel resource, such as a PDCCH or PUCCH. Based at least in part on receiving the backscattered signal, the second UE 120 may decode the PDCCH or PUCCH and obtain information regarding a reading process for reading a tag (of the ambient device 170), information regarding the tag (e.g., a type of data stored by the ambient device 170), or coordination information (e.g., a next time for reading the tag). Additionally, or alternatively, the second UE 120 may decode the backscattered signal to determine data being conveyed via the backscattered signal. In some aspects, the second UE 120 may not decode the backscattered signal, but may buffer in-phase (I) and quadrature (Q) (I/Q) samples of the backscattered signal. In this case, the second UE 120 may relay the I/Q samples to the first UE 120 (e.g., via a PUCCH occasion) to enable the first UE 120 to decode the backscattered signal.

As further shown in FIG. 6, and by reference numbers 625 and 630, the first UE 120 and the second UE 120 may exchange feedback messages. For example, the second UE 120 may transmit a feedback message based at least in part on receiving the tag response, and the first UE 120 may transmit a feedback response based at least in part on receiving the feedback message. In this case, the second UE 120 may transmit an acknowledgement (ACK) feedback message indicating a success at decoding a backscatter signal from the ambient device 170.

Additionally, or alternatively, the second UE 120 may transmit a negative acknowledgment (NACK) feedback message indicating a failure at decoding a backscatter signal from the ambient device 170. The first UE 120 may transmit the feedback response to indicate an end to a tag processing procedure (or another tag processing procedure). For example, based at least in part on the second UE 120 indicating successful reading of a tag of the ambient device 170, the first UE 120 may signal the second UE 120 that tag processing is complete or that the second UE 120 is to read another tag (e.g., associated with the same or another ambient device 170).

In some aspects, the second UE 120 may convey the feedback message via a physical channel, such as a PDCCH or PUCCH. For example, the second UE 120 may transmit a PDCCH with a format 0 message to convey a feedback message. In some aspects, the second UE 120 may report data decoded from the backscatter signal to the first UE 120 to enable the first UE 120 to use the data. In some aspects, the second UE 120 may transmit control information using a feedback resource (e.g., a PUCCH occasion for feedback). For example, the second UE 120 may use a feedback resource to transmit a CSI report (e.g., a precoding matrix indicator (PMI), an RSRP, or an RSRQ), a spatial relationship indicator (SRI) (e.g., a reference signal, such as a CLI SRS, for a QCL relation), a power control command, or a timing parameter, among other examples. Additionally, or alternatively, the second UE 120 may transmit the control information using another message, such as a non-feedback resource channel message.

As indicated above, FIG. 6 is provided as an example. Other examples may differ from what is described with respect to FIG. 6.

FIG. 7 is a diagram illustrating an example process 700 performed, for example, by a first UE, in accordance with the present disclosure. Example process 700 is an example where the first UE (e.g., UE 120) performs operations associated with physical channel based coordination of tag processing.

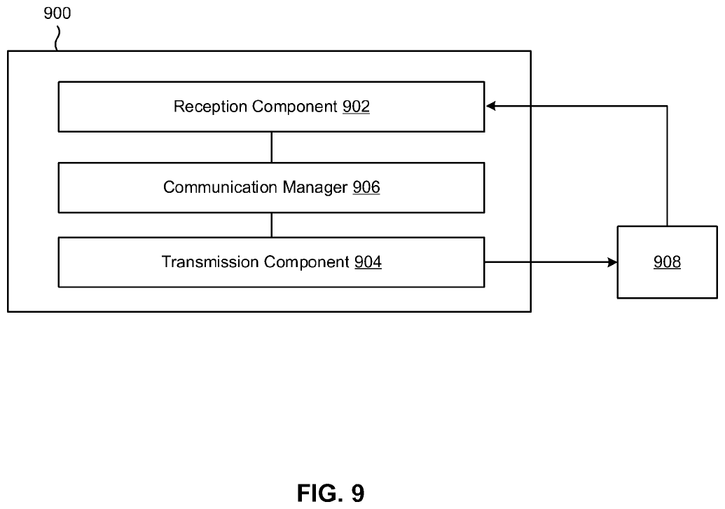

As shown in FIG. 7, in some aspects, process 700 may include transmitting, using a first physical channel message and to a second UE, a coordination message for ambient device processing associated with an ambient device (block 710). For example, the first UE (e.g., using transmission component 904 and/or communication manager 906, depicted in FIG. 9) may transmit, using a first physical channel message and to a second UE, a coordination message for ambient device processing associated with an ambient device, as described above.

As further shown in FIG. 7, in some aspects, process 700 may include transmitting, based at least in part on transmitting the coordination message and to the ambient device, a tag message associated with the ambient device processing (block 720). For example, the first UE (e.g., using transmission component 904 and/or communication manager 906, depicted in FIG. 9) may transmit, based at least in part on transmitting the coordination message and to the ambient device, a tag message associated with the ambient device processing, as described above.

As further shown in FIG. 7, in some aspects, process 700 may include receiving, using a second physical channel message and from the second UE, an ambient device processing feedback message associated with the ambient device processing, based at least in part on transmitting the coordination message and the tag message (block 730). For example, the first UE (e.g., using reception component 902 and/or communication manager 906, depicted in FIG. 9) may receive, using a second physical channel message and from the second UE, an ambient device processing feedback message associated with the ambient device processing, based at least in part on transmitting the coordination message and the tag message, as described above.

Process 700 may include additional aspects, such as any single aspect or any combination of aspects described below and/or in connection with one or more other processes described elsewhere herein.

In a first aspect, the ambient device includes a tag device or a RFID tag device.

In a second aspect, alone or in combination with the first aspect, the ambient device processing includes at least one of transmission of information to the ambient device or reception of information from the ambient device.

In a third aspect, alone or in combination with one or more of the first and second aspects, process 700 includes receiving a coordination message response from the second UE based on transmitting the coordination message, and wherein transmitting the tag message comprises transmitting the tag message based at least in part on receiving the coordination message response.

In a fourth aspect, alone or in combination with one or more of the first through third aspects, process 700 includes transmitting an ambient device processing feedback message response based at least in part on receiving the ambient device processing feedback message.

In a fifth aspect, alone or in combination with one or more of the first through fourth aspects, an interface for at least one of the first physical channel message or the second physical channel message is at least one of a sidelink interface, a Uu link interface, or a dedicated RFID coordination interface.

In a sixth aspect, alone or in combination with one or more of the first through fifth aspects, at least one of the first physical channel message or the second physical channel message includes at least one of a physical downlink control channel message, a physical uplink control channel message, a physical uplink shared channel message, or a physical downlink shared channel message.

In a seventh aspect, alone or in combination with one or more of the first through sixth aspects, process 700 includes communicating with the second UE to determine a UE capability associated with using a control channel message for ambient device processing coordination.

In an eighth aspect, alone or in combination with one or more of the first through seventh aspects, the UE capability is indicated using at least one of a capability information message, an initial access procedure message, a UE class message, or a layer 1, layer 2, or layer 3 indication of a hardware, software, or firmware component.

In a ninth aspect, alone or in combination with one or more of the first through eighth aspects, at least one communication associated with the ambient device processing is transmitted using a plurality of repetitions to enable automated gain control.

In a tenth aspect, alone or in combination with one or more of the first through ninth aspects, process 700 includes receiving configuration information identifying a set of monitoring occasions for at least one communication associated with the ambient device processing.

In an eleventh aspect, alone or in combination with one or more of the first through tenth aspects, the configuration information includes information identifying at least one of a communication format, a control resource set, a search space, an aggregation level, a radio network temporary identifier, or a communication cast type.

In a twelfth aspect, alone or in combination with one or more of the first through eleventh aspects, the configuration information is conveyed via an inter-UE control channel message.

In a thirteenth aspect, alone or in combination with one or more of the first through twelfth aspects, a parameter of the configuration information is conveyed via a field for at least one of a control channel configuration, a control resource set, or a search space set.

In a fourteenth aspect, alone or in combination with one or more of the first through thirteenth aspects, a parameter associated with configuring the ambient device processing is conveyed via a control information field associated with indicating a configuration for a shared channel transmission.

In a fifteenth aspect, alone or in combination with one or more of the first through fourteenth aspects, at least one message associated with the ambient device processing is conveyed via a configured format of control information.

In a sixteenth aspect, alone or in combination with one or more of the first through fifteenth aspects, the control information is associated with a particular priority for resolving a collision with another communication, and is associated with a particular beam configuration or spatial relationship to another transmission.

In a seventeenth aspect, alone or in combination with one or more of the first through sixteenth aspects, process 700 includes performing a cross-link interference measurement and mitigation procedure in connection with one or more communications with the second UE.

In an eighteenth aspect, alone or in combination with one or more of the first through seventeenth aspects, the first UE is configured to receive in-phase or quadrature samples of a backscattered signal associated with the ambient device processing.

In a nineteenth aspect, alone or in combination with one or more of the first through eighteenth aspects, the first UE is configured to receive, via a feedback channel, at least one of a reference signal report, a power control command, a timing command, or a feedback message.

In a twentieth aspect, alone or in combination with one or more of the first through nineteenth aspects, an interpretation of at least one message associated with the ambient device processing is based at least in part on a cyclic shift or orthogonal cover code.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a second UE, in accordance with the present disclosure. Example process 800 is an example where the UE (e.g., UE 120) performs operations associated with physical channel based coordination of tag processing.

As shown in FIG. 8, in some aspects, process 800 may include receiving, using a first physical channel message and from a first UE, a coordination message for ambient device processing associated with an ambient device (block 810). For example, the second UE (e.g., using reception component 902 and/or communication manager 906, depicted in FIG. 9) may receive, using a first physical channel message and from a first UE, a coordination message for ambient device processing associated with an ambient device, as described above.

As further shown in FIG. 8, in some aspects, process 800 may include performing an ambient device processing operation based at least in part on receiving the coordination message (block 820). For example, the second UE (e.g., using communication manager 906, depicted in FIG. 9) may perform an ambient device processing operation based at least in part on receiving the coordination message, as described above.

As further shown in FIG. 8, in some aspects, process 800 may include transmitting, using a second physical channel message and to the first UE, an ambient device processing feedback message associated with the ambient device processing operation (block 830). For example, the second UE (e.g., using transmission component 904 and/or communication manager 906, depicted in FIG. 9) may transmit, using a second physical channel message and to the first UE, an ambient device processing feedback message associated with the ambient device processing operation, as described above.

Process 800 may include additional aspects, such as any single aspect or any combination of aspects described below and/or in connection with one or more other processes described elsewhere herein.

In a first aspect, the ambient device includes a tag device or a RFID tag device.

In a second aspect, alone or in combination with the first aspect, performing the ambient device processing operation comprises at least one of transmitting information to the ambient device, or receiving information from the ambient device.

In a third aspect, alone or in combination with one or more of the first and second aspects, process 800 includes transmitting a coordination message response to the first UE based on receiving the coordination message, and wherein performing the ambient device processing operation comprises performing the ambient device processing operation based at least in part on transmitting the coordination message response.

In a fourth aspect, alone or in combination with one or more of the first through third aspects, process 800 includes receiving an ambient device processing feedback message response based at least in part on transmitting the ambient device processing feedback message.

In a fifth aspect, alone or in combination with one or more of the first through fourth aspects, an interface for at least one of the first physical channel message or the second physical channel message is at least one of a sidelink interface, a Uu link interface, or a dedicated RFID coordination interface.

In a sixth aspect, alone or in combination with one or more of the first through fifth aspects, at least one of the first physical channel message or the second physical channel message includes at least one of a physical downlink control channel message, a physical uplink control channel message, a physical uplink shared channel message, or a physical downlink shared channel message.

In a seventh aspect, alone or in combination with one or more of the first through sixth aspects, process 800 includes communicating with the first UE to determine a UE capability associated with using a control channel message for ambient device processing coordination.

In an eighth aspect, alone or in combination with one or more of the first through seventh aspects, the UE capability is indicated using at least one of a capability information message, an initial access procedure message, a UE class message, or a layer 1, layer 2, or layer 3 indication of a hardware, software, or firmware component.

In a ninth aspect, alone or in combination with one or more of the first through eighth aspects, at least one communication associated with the ambient device processing operation is transmitted using a plurality of repetitions to enable automated gain control.

In a tenth aspect, alone or in combination with one or more of the first through ninth aspects, process 800 includes transmitting configuration information identifying a set of monitoring occasions for at least one communication associated with the ambient device processing operation.

In an eleventh aspect, alone or in combination with one or more of the first through tenth aspects, the configuration information includes information identifying at least one of a communication format, a control resource set, a search space, an aggregation level, a radio network temporary identifier, or a communication cast type.

In a twelfth aspect, alone or in combination with one or more of the first through eleventh aspects, the configuration information is conveyed via an inter-UE control channel message.

In a thirteenth aspect, alone or in combination with one or more of the first through twelfth aspects, a parameter of the configuration information is conveyed via a field for at least one of a control channel configuration, a control resource set, or a search space set.

In a fourteenth aspect, alone or in combination with one or more of the first through thirteenth aspects, a parameter associated with configuring the ambient device processing operation is conveyed via a control information field associated with indicating a configuration for a shared channel transmission.

In a fifteenth aspect, alone or in combination with one or more of the first through fourteenth aspects, at least one message associated with the ambient device processing operation is conveyed via a configured format of control information.

In a sixteenth aspect, alone or in combination with one or more of the first through fifteenth aspects, the control information is associated with a particular priority for resolving a collision with another communication, and is associated with a particular beam configuration or spatial relationship to another transmission.

In a seventeenth aspect, alone or in combination with one or more of the first through sixteenth aspects, process 800 includes performing a cross-link interference measurement and mitigation procedure in connection with one or more communications with the first UE.

In an eighteenth aspect, alone or in combination with one or more of the first through seventeenth aspects, the second UE is configured to transmit in-phase or quadrature samples of a backscattered signal associated with the ambient device processing operation.

In a nineteenth aspect, alone or in combination with one or more of the first through eighteenth aspects, the second UE is configured to transmit, via a feedback channel, at least one of a reference signal report, a power control command, a timing command, or a feedback message.

In a twentieth aspect, alone or in combination with one or more of the first through nineteenth aspects, an interpretation of at least one message associated with the ambient device processing operation is based at least in part on a cyclic shift or orthogonal cover code.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIG. 6. Additionally, or alternatively, the apparatus 900 may be configured to perform one or more processes described herein, such as process 700 of FIG. 7, process 800 of FIG. 8, or a combination thereof. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The transmission component 904 may transmit, using a first physical channel message and to another apparatus, a coordination message for ambient device processing associated with an ambient device. The transmission component 904 may transmit, based at least in part on transmitting the coordination message and to the ambient device, a tag message associated with the ambient device processing. The reception component 902 may receive, using a second physical channel message and from the other apparatus, an ambient device processing feedback message associated with the ambient device processing, based at least in part on transmitting the coordination message and the tag message.

The reception component 902 may receive a coordination message response from the other apparatus based on transmitting the coordination message. The transmission component 904 may transmit an ambient device processing feedback message response based at least in part on receiving the ambient device processing feedback message. The communication manager 906 may communicate with the other apparatus to determine a UE capability associated with using a control channel message for ambient device processing coordination. The reception component 902 may receive configuration information identifying a set of monitoring occasions for at least one communication associated with the ambient device processing. The communication manager 906 may perform a cross-link interference measurement and mitigation procedure in connection with one or more communications with the other UE.

The reception component 902 may receive, using a first physical channel message and from another apparatus, a coordination message for ambient device processing associated with an ambient device. The communication manager 906 may perform an ambient device processing operation based at least in part on receiving the coordination message. The transmission component 904 may transmit, using a second physical channel message and to the other UE, an ambient device processing feedback message associated with the ambient device processing operation.

The transmission component 904 may transmit a coordination message response to the other UE based on receiving the coordination message. The reception component 902 may receive an ambient device processing feedback message response based at least in part on transmitting the ambient device processing feedback message. The communication manager 906 may communicate with the other UE to determine a UE capability associated with using a control channel message for ambient device processing coordination. The transmission component 904 may transmit configuration information identifying a set of monitoring occasions for at least one communication associated with the ambient device processing operation. The communication manager 906 may perform a cross-link interference measurement and mitigation procedure in connection with one or more communications with the other UE.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed by a first user equipment (UE), comprising: transmitting, using a first physical channel message and to a second UE, a coordination message for ambient device processing associated with an ambient device; transmitting, based at least in part on transmitting the coordination message and to the ambient device, a tag message associated with the ambient device processing; and receiving, using a second physical channel message and from the second UE, an ambient device processing feedback message associated with the ambient device processing, based at least in part on transmitting the coordination message and the tag message.
Aspect 2: The method of Aspect 1, wherein the ambient device includes a tag device or a radio frequency identification (RFID) tag device.
Aspect 3: The method of any of Aspects 1-2, wherein the ambient device processing includes at least one of: transmission of information to the ambient device or reception of information from the ambient device.
Aspect 4: The method of any of Aspects 1-3, further comprising: receiving a coordination message response from the second UE based on transmitting the coordination message; and wherein transmitting the tag message comprises: transmitting the tag message based at least in part on receiving the coordination message response.
Aspect 5: The method of any of Aspects 1-4, further comprising: transmitting an ambient device processing feedback message response based at least in part on receiving the ambient device processing feedback message.
Aspect 6: The method of any of Aspects 1-5, wherein an interface for at least one of the first physical channel message or the second physical channel message is at least one of: a sidelink interface, a Uu link interface, or a dedicated RFID coordination interface.
Aspect 7: The method of any of Aspects 1-6, wherein at least one of the first physical channel message or the second physical channel message includes at least one of: a physical downlink control channel message, a physical uplink control channel message, a physical uplink shared channel message, or a physical downlink shared channel message.
Aspect 8: The method of any of Aspects 1-7, further comprising: communicating with the second UE to determine a UE capability associated with using a control channel message for ambient device processing coordination.
Aspect 9: The method of Aspect 8, wherein the UE capability is indicated using at least one of: a capability information message, an initial access procedure message, a UE class message, or a layer 1, layer 2, or layer 3 indication of a hardware, software, or firmware component.
Aspect 10: The method of any of Aspects 1-9, wherein at least one communication associated with the ambient device processing is transmitted using a plurality of repetitions to enable automated gain control.
Aspect 11: The method of any of Aspects 1-10, further comprising: receiving configuration information identifying a set of monitoring occasions for at least one communication associated with the ambient device processing.
Aspect 12: The method of Aspect 11, wherein the configuration information includes information identifying at least one of: a communication format, a control resource set, a search space, an aggregation level, a radio network temporary identifier, or a communication cast type.
Aspect 13: The method of Aspect 11, wherein the configuration information is conveyed via an inter-UE control channel message.
Aspect 14: The method of Aspect 11, wherein a parameter of the configuration information is conveyed via a field for at least one of: a control channel configuration, a control resource set, or a search space set.
Aspect 15: The method of any of Aspects 1-14, wherein a parameter associated with configuring the ambient device processing is conveyed via a control information field associated with indicating a configuration for a shared channel transmission.
Aspect 16: The method of any of Aspects 1-15, wherein at least one message associated with the ambient device processing is conveyed via a configured format of control information.
Aspect 17: The method of Aspect 16, wherein the control information is associated with a particular priority for resolving a collision with another communication, and is associated with a particular beam configuration or spatial relationship to another transmission.
Aspect 18: The method of any of Aspects 1-17, further comprising: performing a cross-link interference measurement and mitigation procedure in connection with one or more communications with the second UE.
Aspect 19: The method of any of Aspects 1-18, wherein the first UE is configured to receive in-phase or quadrature samples of a backscattered signal associated with the ambient device processing.
Aspect 20: The method of any of Aspects 1-19, wherein the first UE is configured to receive, via a feedback channel, at least one of: a reference signal report, a power control command, a timing command, or a feedback message.
Aspect 21: The method of any of Aspects 1-20, wherein an interpretation of at least one message associated with the ambient device processing is based at least in part on a cyclic shift or orthogonal cover code.
Aspect 22: A method of wireless communication performed by a second user equipment (UE), comprising: receiving, using a first physical channel message and from a first UE, a coordination message for ambient device processing associated with an ambient device; performing an ambient device processing operation based at least in part on receiving the coordination message; and transmitting, using a second physical channel message and to the first UE, an ambient device processing feedback message associated with the ambient device processing operation.
Aspect 23: The method of Aspect 22, wherein the ambient device includes a tag device or a radio frequency identification (RFID) tag device.
Aspect 24: The method of any of Aspects 22-23, wherein performing the ambient device processing operation comprises at least one of: transmitting information to the ambient device, or receiving information from the ambient device.
Aspect 25: The method of any of Aspects 22-24, further comprising: transmitting a coordination message response to the first UE based on receiving the coordination message; and wherein performing the ambient device processing operation comprises: performing the ambient device processing operation based at least in part on transmitting the coordination message response.
Aspect 26: The method of any of Aspects 22-25, further comprising: receiving an ambient device processing feedback message response based at least in part on transmitting the ambient device processing feedback message.
Aspect 27: The method of any of Aspects 22-26, wherein an interface for at least one of the first physical channel message or the second physical channel message is at least one of: a sidelink interface, a Uu link interface, or a dedicated RFID coordination interface.
Aspect 28: The method of any of Aspects 22-27, wherein at least one of the first physical channel message or the second physical channel message includes at least one of: a physical downlink control channel message, a physical uplink control channel message, a physical uplink shared channel message, or a physical downlink shared channel message.
Aspect 29: The method of any of Aspects 22-28, further comprising: communicating with the first UE to determine a UE capability associated with using a control channel message for ambient device processing coordination.
Aspect 30: The method of Aspect 29, wherein the UE capability is indicated using at least one of: a capability information message, an initial access procedure message, a UE class message, or a layer 1, layer 2, or layer 3 indication of a hardware, software, or firmware component.
Aspect 31: The method of any of Aspects 22-30, wherein at least one communication associated with the ambient device processing operation is transmitted using a plurality of repetitions to enable automated gain control.
Aspect 32: The method of any of Aspects 22-31, further comprising: transmitting configuration information identifying a set of monitoring occasions for at least one communication associated with the ambient device processing operation.
Aspect 33: The method of Aspect 32, wherein the configuration information includes information identifying at least one of: a communication format, a control resource set, a search space, an aggregation level, a radio network temporary identifier, or a communication cast type.
Aspect 34: The method of Aspect 32, wherein the configuration information is conveyed via an inter-UE control channel message.
Aspect 35: The method of Aspect 32, wherein a parameter of the configuration information is conveyed via a field for at least one of: a control channel configuration, a control resource set, or a search space set.
Aspect 36: The method of any of Aspects 22-35, wherein a parameter associated with configuring the ambient device processing operation is conveyed via a control information field associated with indicating a configuration for a shared channel transmission.
Aspect 37: The method of any of Aspects 22-36, wherein at least one message associated with the ambient device processing operation is conveyed via a configured format of control information.
Aspect 38: The method of Aspect 37, wherein the control information is associated with a particular priority for resolving a collision with another communication, and is associated with a particular beam configuration or spatial relationship to another transmission.
Aspect 39: The method of any of Aspects 22-38, further comprising: performing a cross-link interference measurement and mitigation procedure in connection with one or more communications with the first UE.
Aspect 40: The method of any of Aspects 22-39, wherein the second UE is configured to transmit in-phase or quadrature samples of a backscattered signal associated with the ambient device processing operation.
Aspect 41: The method of any of Aspects 22-40, wherein the second UE is configured to transmit, via a feedback channel, at least one of: a reference signal report, a power control command, a timing command, or a feedback message.
Aspect 42: The method of any of Aspects 22-41, wherein an interpretation of at least one message associated with the ambient device processing operation is based at least in part on a cyclic shift or orthogonal cover code.
Aspect 43: An apparatus for wireless communication at a device, comprising a processor; memory coupled with the processor; and instructions stored in the memory and executable by the processor to cause the apparatus to perform the method of one or more of Aspects 1-42.
Aspect 44: A device for wireless communication, comprising a memory and one or more processors coupled to the memory, the one or more processors configured to perform the method of one or more of Aspects 1-42.
Aspect 45: An apparatus for wireless communication, comprising at least one means for performing the method of one or more of Aspects 1-42.
Aspect 46: A non-transitory computer-readable medium storing code for wireless communication, the code comprising instructions executable by a processor to perform the method of one or more of Aspects 1-42.
Aspect 47: A non-transitory computer-readable medium storing a set of instructions for wireless communication, the set of instructions comprising one or more instructions that, when executed by one or more processors of a device, cause the device to perform the method of one or more of Aspects 1-42.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first user equipment (UE) for wireless communication, comprising:
a memory; and
one or more processors, coupled to the memory, configured to:
transmit, using a first physical channel message and to a second UE, a coordination message for ambient device processing associated with an ambient device;
transmit, based at least in part on transmitting the coordination message and to the ambient device, a tag message associated with the ambient device processing; and
receive, using a second physical channel message and from the second UE, an ambient device processing feedback message associated with the ambient device processing, based at least in part on transmitting the coordination message and the tag message.

2. The UE of claim 1, wherein the ambient device includes a tag device or a radio frequency identification (RFID) tag device.

3. The UE of claim 1, wherein the ambient device processing includes at least one of: transmission of information to the ambient device or reception of information from the ambient device.

4. The UE of claim 1, wherein the one or more processors are further configured to:
receive a coordination message response from the second UE based on transmitting the coordination message; and
wherein the one or more processors, to transmit the tag message, are configured to:
transmit the tag message based at least in part on receiving the coordination message response.

5. The UE of claim 1, wherein the one or more processors are further configured to:
transmit an ambient device processing feedback message response based at least in part on receiving the ambient device processing feedback message.

6. The UE of claim 1, wherein an interface for at least one of the first physical channel message or the second physical channel message is at least one of:
a sidelink interface,
a Uu link interface, or
a dedicated RFID coordination interface.

7. The UE of claim 1, wherein at least one of the first physical channel message or the second physical channel message includes at least one of:
a physical downlink control channel message,
a physical uplink control channel message,
a physical uplink shared channel message, or
a physical downlink shared channel message.

8. The UE of claim 1, wherein the one or more processors are further configured to:
communicate with the second UE to determine a UE capability associated with using a control channel message for ambient device processing coordination.

9. The UE of claim 8, wherein the UE capability is indicated using at least one of:
a capability information message,
an initial access procedure message,
a UE class message, or
a layer 1, layer 2, or layer 3 indication of a hardware, software, or firmware component.

10. The UE of claim 1, wherein at least one communication associated with the ambient device processing is transmitted using a plurality of repetitions to enable automated gain control.

11. The UE of claim 1, wherein the one or more processors are further configured to:
receive configuration information identifying a set of monitoring occasions for at least one communication associated with the ambient device processing.

12. The UE of claim 11, wherein the configuration information includes information identifying at least one of:
a communication format,
a control resource set,
a search space,
an aggregation level,
a radio network temporary identifier, or
a communication cast type.

13. The UE of claim 11, wherein the configuration information is conveyed via an inter-UE control channel message.

14. The UE of claim 11, wherein a parameter of the configuration information is conveyed via a field for at least one of:
a control channel configuration,
a control resource set, or
a search space set.

15. The UE of claim 1, wherein a parameter associated with configuring the ambient device processing is conveyed via a control information field associated with indicating a configuration for a shared channel transmission.

16. A second user equipment (UE) for wireless communication, comprising:
a memory; and
one or more processors, coupled to the memory, configured to:
receive, using a first physical channel message and from a first UE, a coordination message for ambient device processing associated with an ambient device;
perform an ambient device processing operation based at least in part on receiving the coordination message; and
transmit, using a second physical channel message and to the first UE, an ambient device processing feedback message associated with the ambient device processing operation.

17. The UE of claim 16, wherein the second UE is configured to transmit in-phase or quadrature samples of a backscattered signal associated with the ambient device processing operation.

18. The UE of claim 16, wherein the second UE is configured to transmit, via a feedback channel, at least one of:
a reference signal report,
a power control command,
a timing command, or
a feedback message.

19. The UE of claim 16, wherein an interpretation of at least one message associated with the ambient device processing operation is based at least in part on a cyclic shift or orthogonal cover code.

20. A method of wireless communication performed by a first user equipment (UE), comprising:
transmitting, using a first physical channel message and to a second UE, a coordination message for ambient device processing associated with an ambient device;
transmitting, based at least in part on transmitting the coordination message and to the ambient device, a tag message associated with the ambient device processing; and
receiving, using a second physical channel message and from the second UE, an ambient device processing feedback message associated with the ambient device processing, based at least in part on transmitting the coordination message and the tag message.
